(19) United States
(12) Patent Application Publication
(10) Pub. No.: US 2020/0133097 A1
(43) Pub. Date: Apr. 30, 2020

(54) CONTROL DEVICE, MOVING BODY, CONTROL METHOD AND PROCEDURE

(71) Applicant: SZ DJI TECHNOLOGY CO., LTD., Shenzhen (CN)

(72) Inventors: Kenichi HONJO, Shenzhen (CN); Tomonaga YASUDA, Shenzhen (CN)

(21) Appl. No.: 16/723,058

(22) Filed: Dec. 20, 2019

Related U.S. Application Data
(63) Continuation of application No. PCT/CN2017/115460, filed on Dec. 11, 2017.

(30) Foreign Application Priority Data
Jul. 19, 2017 (JP) 2017-140353

(51) Int. Cl. G03B 17/14; B64D 47/08; G03B 9/02; G02B 7/10; G03B 17/04; B64C 39/02

(52) U.S. Cl. CPC G03B 17/14; B64D 47/08; G03B 9/02; B64D 2045/008; G03B 17/04; B64C 39/024; B64C 2201/18; G02B 7/102

(57) ABSTRACT

A control device includes a memory storing a program and a processor configured to execute the program to restrict movement of a movable body in response to detecting that a mounting state of a detachable lens assembly at a photographing device of the movable body does not satisfy a pre-set condition.

### CROSS-REFERENCES TO RELATED APPLICATIONS

This application is a continuation of International Application No. PCT/CN2017/115460, filed on Dec. 11, 2017, which claims priority to Japanese Patent Application No. 2017-140353, filed on Jul. 19, 2017, the entire contents of both of which are incorporated herein by reference.

### TECHNICAL FIELD

The present disclosure relates to the technical field of control technology and, more particularly, to a control device, a moving body (movable body), a control method and procedure.

### BACKGROUND

It is desired that when a digital camera is detected to fall, the lens barrel is contracted.

Japanese Patent Application Publication No. 2008-22060.

### SUMMARY

In accordance with the disclosure, there is provided a control device including a memory storing a program and a processor configured to execute the program to restrict movement of a movable body in response to detecting that a mounting state of a detachable lens assembly at a photographing device of the movable body does not satisfy a pre-set condition.

Also in accordance with the disclosure, there is provided a movable body including a photographing device and a control device configured to restrict movement of the movable body in response to detecting that a mounting state of a detachable lens assembly at the photographing device does not satisfy a pre-set condition.

Also in accordance with the disclosure, there is provided a control method including determining whether a mounting state of a detachable lens assembly at a photographing device of a movable body satisfies a pre-set condition and restricting movement of the movable body in response to determining that the mounting state of the detachable lens assembly does not satisfy the pre-set condition.

### BRIEF DESCRIPTION OF THE DRAWINGS

FIG. 1 is a schematic diagram of the appearance of an unmanned aerial vehicle (UAV) and a remote operation device according to an example embodiment of the present disclosure.

FIG. 2 is a functional block diagram of the UAV according to an example embodiment of the present disclosure.

FIG. 3A is a schematic diagram of a lock pin and an electrical contact according to an example embodiment of the present disclosure.

FIG. 3B is a schematic diagram of a lock pin and an electrical contact according to another example embodiment of the present disclosure.

FIG. 3C is a schematic diagram of a lock pin and an electrical contact according to another example embodiment of the present disclosure.

FIG. 3D is a schematic diagram of a lock pin and an electrical contact according to another example embodiment of the present disclosure.

FIG. 4 is a flowchart of a flight restriction procedure of the UAV according to a mounting state of a lens assembly at a photographing device according to an example embodiment of the present disclosure.

FIG. 5 is a block diagram of a hardware device according to an example embodiment of the present disclosure.

### DETAILED DESCRIPTION OF THE EMBODIMENTS

Hereinafter, the present disclosure will be described in the embodiments of the present disclosure. However, the embodiments are not intended to limit the invention as defined in claims. Moreover, not all feature combinations described in the specification are necessary for the technical solutions of the disclosure. It should be understood by those skilled in the art that various modifications and improvements can be made to the embodiments described below. It can be understood from the description of the claims that such modifications or improvements are within the scope of the present disclosure.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The various embodiments of the present disclosure can be described with reference to flowcharts and block diagrams. The blocks in the block diagram may represent (1) a stage or a step of a process of performing an operation, or (2) a circuit of a device for performing an operation. The specially designated stage or circuit may be implemented by a programmable circuit and/or a processor. The specially designated circuit may include a digital and/or analog hardware circuit, and may include an integrated circuit (IC) and/or a discrete circuit. The programmable circuit may include a reconfigurable circuit. The reconfigurable circuit may include a logic AND, a logic OR, a logic XOR, a logic NAND, a logic NOR, other logic operators, a flip-flop, a register, a field programmable gate array (FPGA), a programmable logic array (PLA), and other memory circuits.

A computer-readable medium may include any tangible device that can store instructions to be executed by a suitable device. As s result, the computer-readable medium storing the instructions is a product containing executable instructions. The executable instructions are means for performing the operations designated in the flowcharts or the block diagrams. For illustrative purposes, the computer-readable medium may include an electronic storage medium, a magnetic storage medium, an optical storage medium, an electromagnetic storage medium, or a semiconductor storage medium, etc. For example, the computer-readable medium may include a floppy (registered trade mark) disk, a soft magnetic disk, a hard disk, a random-access memory (RAM), a read-only memory (ROM), an erasable programable read-only memory (EPROM), an electrically erasable programable read-only memory (EEPROM), a static random-access memory (SRAM), a micro optical read-only memory (CD-ROM), a digital versatile disc (DVD), a Blu-ray (registered trade mark) disk, a memory stick, or an integrated circuit card, etc.

The computer-readable instructions may include any of source code or object code described in any combination of one or more programming languages. The source code or the object code includes an existing procedural programming language. The existing procedural programming language may be assembly instructions, instruction set architecture (ISA) instructions, machine instructions, machine dependent instructions, microcode, firmware instructions, state setting data, object-oriented programming languages such as Smalltalk, JAVA®, C++, C programming language, or similar programming languages. The computer-readable instructions may be supplied locally or through a local area network (LAN) or a wide area network (WAN) such as Internet to a general-purpose computer, a special-purpose computer, a processor in other programmable data processing device, or a programmable circuit. The processor or the programmable circuit may be the means for executing the computer-readable instructions to perform the operations designated in the flowcharts or the block diagrams. For example, the processor may be a computer processor, a processing unit, a microprocessor, a digital signal processor, a controller, or a microcontroller, etc.

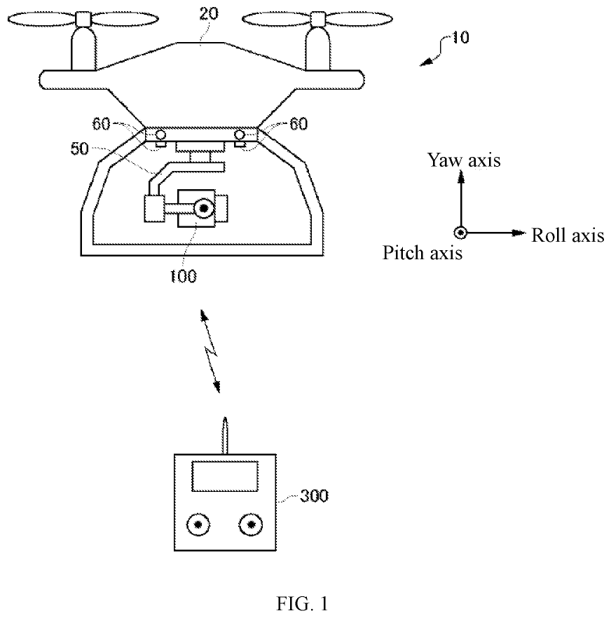

FIG. 1 is a schematic diagram showing an unmanned aerial vehicle (UAV) 10 and a remote operation device 300 according to an example embodiment of the present disclosure. As shown in FIG. 1, the UAV 10 includes a UAV main body 20, a gimbal 50, a plurality of photographing devices 60, and a photographing device 100. The UAV 10 is one example of a movable body propelled by a propulsion system. In addition to the UAV, the concept of the movable body also includes other flying objects such as an aircraft moving in the air, a vehicle moving on the ground, or a vessel moving on the water, etc.

The UAV main body 20 includes a plurality of rotors. The plurality of rotors is one example of propulsion systems. The UAV main body 20 can cause the UAV 10 to fly by controlling the rotation of the plurality of rotors. For example, the UAV main body 20 includes four rotors to cause the UAV 10 to fly. The number of the rotors may not be limited to four. Further, the UAV 10 may be a rotor-less fixed-wing aircraft.

The photographing device 100 is a camera that photographs a target object within an expected photographing range. The gimbal 50 supports the photographing device 100 by changing the attitude of the photographing device 100. The gimbal 50 supports the photographing device 100 by rotating the photographing device 100. The gimbal 50 is one example of supporting mechanisms. For example, the gimbal 50 supports the photographing device 100 by using an actuator to rotate the photographing device 100 around a pitch axis. The gimbal 50 supports the photographing device 100 by using the actuator to rotate the photographing device 100 around a roll axis and a yaw axis, respectively. The gimbal 50 changes the attitude of the photographing device 100 by rotating the photographing device 100 around at least one of the yaw axis, the pitch axis, or the roll axis.

The plurality of photographing devices 60 can be sensing cameras that photograph surroundings of the UAV 10 for controlling flight of the UAV 10. Two photographing devices 60 are disposed at the front of the UAV 10, that is, facing toward the front side. Two additional photographing devices 60 are disposed at the bottom side of the UAV 10. The two front side photographing devices 60 are paired and function as a three-dimensional (3D) camera. The two bottom side photographing devices 60 are also paired and functioned as the 3D camera. Images photographed by the plurality of photographing devices 60 are combined to generate 3D spatial data surrounding the UAV 10. The number of the photographing devices 60 mounted at the UAV 10 is not limited to four. The UAV 10 includes at least one photographing device 60. The UAV 10 may include at least one photographing device 60 at each of the front side, the rear side, the left side, the right side, the bottom side, and the top side of the UAV 10. A configurable viewing angle of each of the plurality of photographing devices 60 may be greater than a configurable view angle of the photographing device 100. Each photographing device 60 may include a fixed focus lens or a fisheye lens.

As shown in FIG. 1, the remote operation device 300 communicates with the UAV 10 to remotely control the operation of the UAV 10. The remote operation device 300 may communicate with the UAV 10 wirelessly. The remote operation device 300 sends driving information to the UAV 10. The driving information includes various driving instructions related to movements of the UAV 10, such as ascending, descending, accelerating, decelerating, advancing, retreating, and rotating, etc. For example, the driving information includes the instruction causing the UAV 10 to ascend. The driving information may indicate a target height of the UAV 10. In response to the instruction, the UAV 10 moves to the target height as indicated by the driving information received from the remote operation device 300. The driving information includes the ascending instruction causing the UAV 10 to ascend. In response to the ascending instruction, the UAV 10 ascends. In response to the ascending instruction, the UAV 10 may not ascend if the target height as indicated by the driving information received from the remote operation device 300 has already been reached.

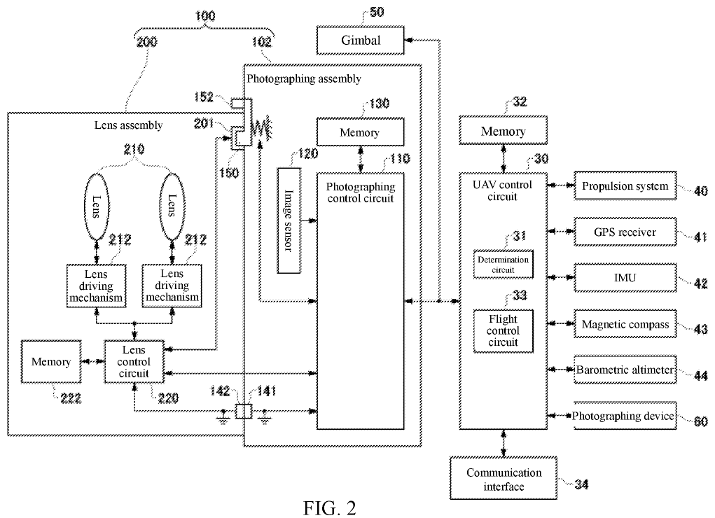

FIG. 2 is a functional block diagram of the UAV 10 according to an example embodiment of the present disclosure. As shown in FIG. 2, the UAV 10 includes a UAV control circuit 30 (UAV controller), a memory 32, a communication interface 34, a propulsion system 40, a GPS receiver 41, an inertial measurement unit (IMU) 42, a magnetic compass 43, a barometric altimeter 44, the gimbal 50, the one or more photographing devices 60, and the photographing device 100.

The communication interface 34 communicates with the remote operation device 300 and other devices. The communication interface 34 receives instruction information. The instruction information includes various instructions from the remote operation device 300 to the UAV control circuit 30. The memory 32 stores programs for the UAV control circuit 30 to control the propulsion system 40, the GPS receiver 41, the IMU 42, the magnetic compass 43, the barometric altimeter 44, the gimbal 50, the one or more photographing devices 60, and the photographing device 100. The memory 32 is a computer-readable storage medium including at least one of an SRAM, a DRAM, an EPROM, an EEPROM, or a USB flash memory. The memory 32 can be disposed inside the UAV main body 20. The memory 32 may be configured to be removable from the UAV main body 20.

The UAV control circuit 30 controls the flight of the UAV 10 and the operation of the photographing device 100 according to the programs stored in the memory 32. The UAV control circuit 30 includes a microprocessor such as a CPU or an MPU, or a microcontroller such as an MCU. The UAV control circuit 30 controls the flight of the UAV 10 and the operation of the photographing device 100 according to the instructions received from the remote operation device 300 through the communication interface 34. The propulsion system 40 propels the UAV 10. The propulsion system 40 includes a plurality of rotors and a plurality of motors for driving the plurality of rotors to rotate. According to the driving instructions from the UAV control circuit 30, the propulsion system 40 uses the plurality of motors to drive the plurality of rotors to rotate, thereby causing the UAV 10 to fly.

The GPS receiver 41 receives a plurality of signals indicating the time of transmission from a plurality of GPS satellites. Based on the plurality of received signals, the GPS receiver 41 calculates a position of the GPS receiver 41, that is, a position of the UAV 10. The IMU 42 detects the attitude of the UAV 10. The attitude of the UAV 10 detected by the IMU 42 includes accelerations in three axes including a front-rear axis, a left-right axis, and a top-bottom axis, and angular velocities in three axial directions of pitch, roll, and yaw axes. The magnetic compass 43 detects orientation of the front of the UAV 10. The barometric altimeter 44 detects the flight height of the UAV 10. The barometric altimeter 44 detects an air pressure around the UAV 10 and converts the detected air pressure into the height, thereby detecting the flight height.

The photographing device 100 includes a photographing assembly 102 and a lens assembly 200. The lens assembly 200 is one example of lens devices. The photographing assembly 102 includes an image sensor 120, a photographing control circuit 110 (photographing controller), and a memory 130. The image sensor 120 may be a CCD or CMOS image sensor. The image sensor 120 outputs image data of optical images captured by a plurality of lenses 210 to the photographing control circuit 110. The photographing control circuit 110 includes a microprocessor such as a CPU or an MPU, or a microcontroller such as an MCU. The photographing control circuit 110 controls the photographing device 100 according to an operation instruction for the photographing device 100 received from the UAV control circuit 30. The memory 130 is a computer-readable storage medium including at least one of an SRAM, a DRAM, an EPROM, an EEPROM, or a USB flash memory. The memory 130 stores programs for the photographing control circuit 110 to control the image sensor 120. The memory 130 can be disposed inside the housing of the photographing device 100. The memory 130 may be configured to be removable from the housing of the photographing device 100.

The lens assembly 200 includes a plurality of lenses 210, a plurality of lens driving mechanisms 212, a lens control circuit 220 (lens controller), and a memory 222. The plurality of lenses 210 may function as a zoom lens, a variable focus lens, or a fixed focus lens. Some or all of the plurality of lenses 210 are configured to move along an optical axis. The lens assembly 200 may be detachable from the photographing assembly 102. The plurality of lens driving mechanisms 212 move some or all of the plurality of lenses 210 along the optical axis. According to a lens control instruction from the photographing assembly 102, the lens control circuit 220 drives the plurality of lens driving mechanisms 212 to make one or more lenses move along the optical axis. The lens control instruction includes, for example, a zoom control instruction and a focus control instruction.

The photographing assembly 102 includes an electrical contact 141. The lens assembly 200 includes an electrical contact 142. The photographing assembly 102 and the lens assembly 200 are electrically connected through the electrical contact 141 and the electrical contact 142. The photographing assembly 102 includes a lock pin 150. The lens assembly 200 includes an insertion hole 201 into which the lock pin 150 is inserted. When the lock pin 150 is inserted in the insertion hole 201, the photographing assembly 102 and the lens assembly 200 are mechanically fixed.

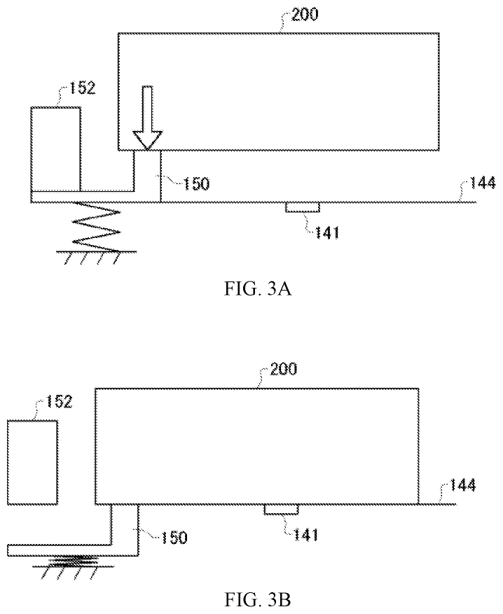

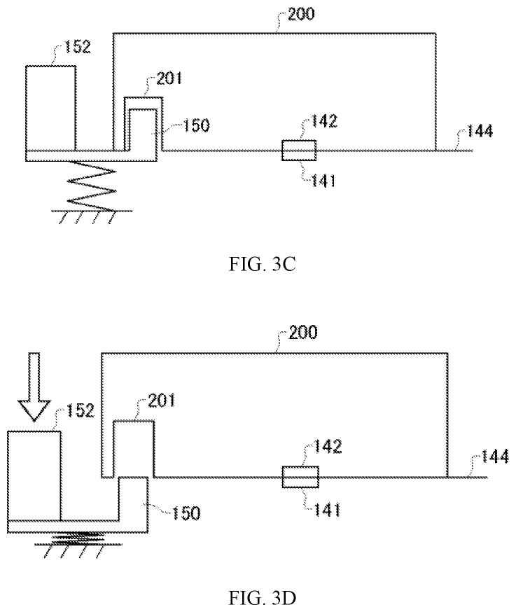

FIGS. 3A-3D are schematic diagrams showing a lock pin and an electrical contact according to an example embodiment of the present disclosure. FIG. 3A shows the state in which the lens assembly 200 is being detached from the photographing assembly 102. In this state, the lens assembly 200 is disposed opposite to a mounting surface 144 of the photographing assembly 102. As shown in FIG. 3B, when the lens assembly 200 is pressed against the mounting surface 144 of the photographing assembly 102 and rotated, the lock pin 150 is pressed to unlock the lock pin 150. The photographing assembly 102 includes a switch that unlocks the lock pin 150 by pressing the lock pin 150. By detecting on/off state of the switch, the photographing assembly 102 determines whether the lock pin 150 is unlocked. As shown in FIG. 3C, when the lens assembly 200 is rotated to a pre-set position with respect to the photographing assembly 102, the lock pin 150 is inserted in the insertion hole 201 disposed on the lens assembly 200, and the electrical contact 141 of the photographing assembly 102 is electrically connected to the electrical contact 142 of the lens assembly 200. When the lock pin 150 is inserted in the insertion hole 201, the lens assembly 200 is unable to rotate with respect to the photographing assembly 102, and the photographing assembly 102 and the lens assembly 200 are mechanically fixed. As shown in FIG. 3D, to detach the lens assembly 200 is from the photographing assembly 102, a lock release button 152 disposed on the photographing assembly 102 is pressed down. As such, the lock pin 150 may be pulled out from the insertion hole 201. After the lock pin 150 is pulled out from the insertion hole 201, the mechanical fixing between the photographing assembly 102 and the lens assembly 200 is released, and the lens assembly 200 is able to rotate with respect to the photographing assembly 102. When the lens assembly 200 rotates to a pre-set position with respect to the photographing assembly 102, the lens assembly 200 may be detached from the photographing assembly 102.

In the photographing device, when the lens assembly 200 is not secured at the photographing device 100, failure is possible. For example, when the UAV 10 flies while the lens assembly 200 is not secured at the photographing device 100, photographing by the photographing device 100 is affected. In addition, during the flight of the UAV 10, because the photographing device vibrates, the lens assembly 200 abnormally mounted on the photographing device 100 may affect the photographing by the photographing device 100.

Therefore, in the UAV 10, when a mounting state of the lens assembly 200 on the photographing device 100 does not satisfy a pre-set condition, the flight of the UAV 10 is restricted. As such, the lens assembly 200 is prevented from failing when the mounting state of the lens assembly 200 on the photographing device 100 does not satisfy the pre-set condition.

To restrict the flight of the UAV 10, the UAV control circuit 30 includes a determination circuit 31 and a flight control circuit 33. The flight control circuit 33 is one example of control circuits. The determination circuit 31 determines whether the mounting state of the lens assembly 200 on the photographing device 100 satisfies the pre-set condition. The determination circuit 31 determines whether the lens assembly 200 is mechanically connected to a pre-set fixing position with respect to the photographing device 100. Before the UAV 10 takes off, the determination circuit 31 determines whether the mounting state of the lens assembly 200 on the photographing device 100 satisfies the pre-set condition. During the flight of the UAV 10, the determination circuit 31 determines whether the mounting state of the lens assembly 200 on the photographing device 100 satisfies the pre-set condition.

When the lens assembly 200 is not mechanically fixed to the photographing device 100 by the lock pin 150, the determination circuit 31 determines that the mounting state of the lens assembly 200 on the photographing device 100 does not satisfy the pre-set condition. When the lock pin 150 is pressed down, that is, when the lock pin 150 is unlocked, the determination circuit 31 determines that the mounting state of the lens assembly 200 on the photographing device 100 does not satisfy the pre-set condition.

When the lens assembly 200 is not electrically connected to the photographing device 100 through the electrical contact 141 and the electrical contact 142, the determination circuit 31 determines that the mounting state of the lens assembly 200 on the photographing device 100 does not satisfy the pre-set condition. When the lens assembly 200 is mechanically fixed to the photographing device 100 by the lock pin 150 and the lens assembly 200 is electrically connected to the photographing device 100 through the electrical contact 141 and the electrical contact 142, the determination circuit 31 determines that the mounting state of the lens assembly 200 on the photographing device 100 satisfies the pre-set condition. When the lock pin 150 is not pressed down, that is, when the lock pin 150 is locked, and the lens assembly 200 is electrically connected to the photographing device 100 through the electrical contact 141 and the electrical contact 142, the determination circuit 31 determines that the mounting state of the lens assembly 200 on the photographing device 100 satisfies the pre-set condition.

When the mounting state of the lens assembly 200 on the photographing device 100 does not satisfy the pre-set condition, the flight control circuit 33 restricts the flight of the UAV 10. Before the UAV 10 takes off, and when the determination circuit 31 determines that the mounting state of the lens assembly 200 on the photographing device 100 does not satisfy the pre-set condition, the flight control circuit 33 restricts the flight of the UAV 10. During the flight of the UAV 10, and when the determination circuit 31 determines that the mounting state of the lens assembly 200 on the photographing device 100 does not satisfy the pre-set condition, the flight control circuit 33 restricts the flight of the UAV 10. During the flight of the UAV 10, and when the determination circuit 31 determines that the mounting state of the lens assembly 200 on the photographing device 100 does not satisfy the pre-set condition, the flight control circuit 33 causes the UAV 10 to land. During the flight of the UAV 10, and when the determination circuit 31 determines that the mounting state of the lens assembly 200 on the photographing device 100 does not satisfy the pre-set condition, the flight control circuit 33 causes the UAV 10 to land at a pre-set landing area. During the flight of the UAV 10, and when the determination circuit 31 determines that the mounting state of the lens assembly 200 on the photographing device 100 does not satisfy the pre-set condition, the flight control circuit 33 causes the UAV 10 to land at a landable area closest to a current position of the UAV 10.

During the flight of the UAV 10, and when the determination circuit 31 determines that the mounting state of the lens assembly 200 on the photographing device 100 does not satisfy the pre-set condition, the flight control circuit 33 restricts attitude control of the photographing device 100 by the gimbal 50. During the flight of the UAV 10, and when the determination circuit 31 determines that the mounting state of the lens assembly 200 on the photographing device 100 does not satisfy the pre-set condition, the flight control circuit 33 prohibits the rotation of the photographing device 100 driven by the gimbal 50. Prohibiting the rotation of the photographing device 100 prevents the mounting state of the lens assembly 200 on the photographing device 100 from being further deteriorated.

During the flight of the UAV 10, and when the determination circuit 31 determines that the mounting state of the lens assembly 200 on the photographing device 100 does not satisfy the pre-set condition, the flight control circuit 33 notifies a user that the mounting state of the lens assembly 200 on the photographing device 100 does not satisfy the pre-set condition. During the flight of the UAV 10, and when the determination circuit 31 determines that the mounting state of the lens assembly 200 on the photographing device 100 does not satisfy the pre-set condition, the flight control circuit 33 notifies the user to land the UAV 10 at a safe area. The flight control circuit 33 notifies the user by displaying a message indicating that the mounting state of the lens assembly 200 on the photographing device 100 does not satisfy the pre-set condition on a display unit of the remote operation device 300. During the flight of the UAV 10, and when the determination circuit 31 determines that the mounting state of the lens assembly 200 on the photographing device 100 does not satisfy the pre-set condition, the flight control circuit 33 notifies the user by displaying a warning message requesting emergency landing on the display unit of the remote operation device 300.

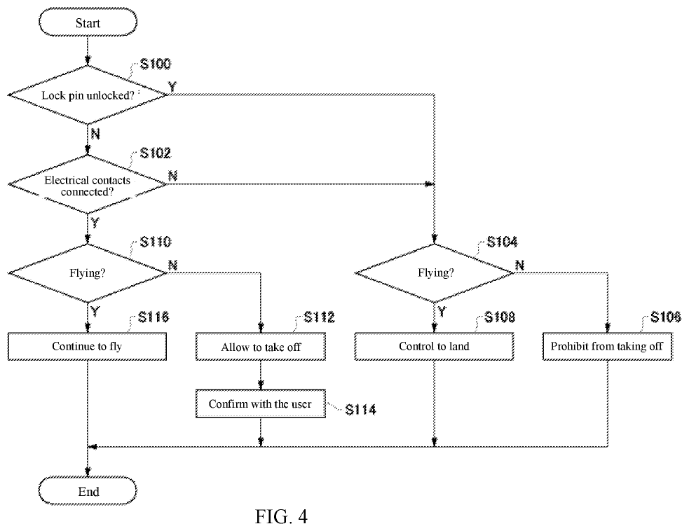

FIG. 4 is a flowchart of a flight restriction procedure of the UAV according to a mounting state of a lens assembly at a photographing device according to an example embodiment of the present disclosure.

In some embodiments, the determination circuit 31 determines whether the lock pin 150 is unlocked or locked (S100). When the lock pin 150 is locked, the determination circuit 31 determines whether the electrical contact 141 and the electrical contact 142 are connected (S102). The determination circuit 31 determines whether the electrical contact 141 and the electrical contact 142 are electrically connected. When the determination circuit 31 determines that the electrical contact 141 and the electrical contact 142 are disconnected, the flight control circuit 33 determines that the lens assembly 200 may have been mounted abnormally on the photographing device 100, and further determines whether the UAV 10 is flying (S104).

When the result of the determination at S100 is that the lock pin 150 is unlocked, the flight control circuit 33 determines that the lens assembly 200 may have been mounted abnormally on the photographing device 100, and further determines whether the UAV 10 is flying (S104).

At S104, the flight control circuit 33 determines whether the UAV 10 is flying based on whether the motors are driving the rotors. When the UAV 10 is not flying, that is, before the UAV 10 takes off, the flight control circuit 33 prohibits the UAV 10 from taking off (S106). Because the lens assembly 200 may have been mounted abnormally on the photographing device 100, the flight control circuit 33 notifies the user that the flight of the photographing device 10 cannot start, for example, through the remote operation device 300. The flight control circuit 33 prohibits the photographing device 100 from taking off until the lens assembly 200 is mounted normally on the photographing device 100.

When the result of the determination at step S104 is that the UAV 10 is flying, the flight control circuit 33 causes the UAV 10 to land (S108). The flight control circuit 33 forces the UAV 10 to land at the pre-set landing area.

When the result of the determination at S102 is that the electrical contact 141 and the electrical contact 142 are connected, the flight control circuit 33 determines that the lens assembly 200 is mounted normally on the photographing device 100, and further determines whether the UAV 10 is flying (S110). When the UAV 10 is flying, the flight control circuit 33 does not restrict the flight of the UAV 10 and causes the UAV 10 to continue the flight (S116). When the UAV 10 is not flying, that is, before the UAV 10 takes off, the flight control circuit 33 allows the UAV 10 to take off (S112). Then, the flight control circuit 33 notifies the user of permission to fly, and confirms with the user (S114). For example, the flight control circuit 33 displays a button for confirming the permission to fly on the display unit of the remote operation device 300. Then, when it is detected that the button is pressed, the flight control circuit 33 causes the UAV 10 to take off. In addition, the flight control circuit 33 may cause the UAV 10 to take off without confirming with the user after the flight control circuit 33 allows the UAV 10 to take off.

As described above, at the UAV 10, when the mounting state of the lens assembly 200 on the photographing device 100 does not satisfy the pre-set condition, the UAV 10 is restricted from flying. As such, it is possible to prevent in advance the failure from occurring when the mounting state of the lens assembly 200 on the photographing device 100 does not satisfy the pre-set condition.

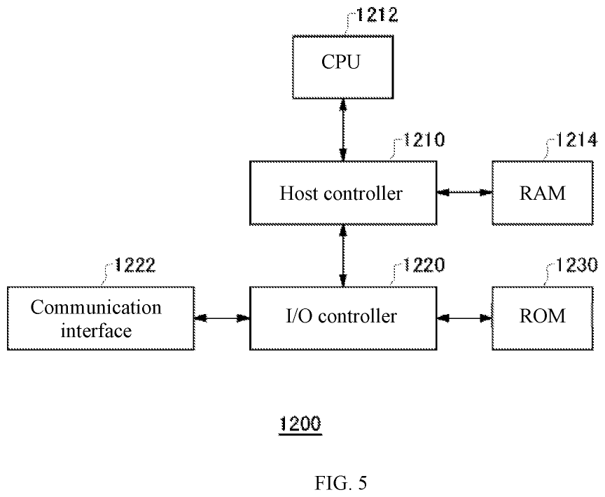

FIG. 5 is a block diagram of a hardware device according to an example embodiment of the present disclosure. As shown in FIG. 5, a program installed in the computer 1200 enables the computer 1200 to perform related operations of the device or function as one or more “parts” of the device. The program enables the computer 1200 to perform the operations or function as the one or more “parts”. The program enables the computer 1200 to perform a process or a stage of the process according to the embodiments of the present disclosure. The program is executed by a CPU 1212 to cause the computer 1200 to perform certain operations related to some or all of the flowcharts and function blocks described in the specification.

In some embodiments, the computer 1200 include the CPU 1212 and a RAM 1214. The CPU 1212 and the RAM 1214 are connected through a host controller 1210. The computer 1200 also includes a communication interface 1222 and an input/output circuit. The communication interface 1222 and the input/output circuit are connected to the host controller 1210 through an input/output controller 1220. The computer 1200 also includes a ROM 1230. The CPU 1212 executes programs stored in the ROM 1230 and the RAM 1214 to control each circuit.

The communication interface 1222 communicates with other electronic devices through a network. A hard drive stores the programs and data for use by the CPU 1212 of the computer 1200. The ROM 1230 stores a boot program for booting the computer 1200 and/or other programs dependent on the hardware of the computer 1200. The programs are supplied by computer-readable storage medium such as a CD-ROM, a USB memory or an IC card or through the network. The programs are installed in the RAM 1214 or the ROM 1230, which are also examples of the computer readable storage medium, and are executed by the CPU 1212. Information processing described in the programs is retrieved by the computer 1200, enabling cooperation between the programs and various types of hardware resources. The device or the method may be implemented by enabling the computer 1200 to perform the operation or processing of information.

For example, when the computer 1200 communicates with the external devices, the CPU 1212 executes a communication program loaded in the RAM 1214, and instructs the communication interface 1222 to perform a communication process based on the processing described in the communication program. Controlled by the CPU 1212, the communication interface 1222 retrieves transmission data stored in a transmitting buffer provided by the storage medium such as the RAM 1214 or the USB memory, transmits the transmission data to the network, or writes data received from the network into a receiving buffer provided on the storage medium.

Moreover, the CPU 1212 retrieves all or required part of files or databases stored in the external storage medium such as the USB memory and writes into the RAM 1214, and performs various types of processing on the data stored in the RAM 1214. Then, the CPU 1212 writes back the processed data to the external storage medium.

Various types of information such as programs, data, tables, and databases are stored in the storage medium and are subject to information processing. The CPU 1212 performs various types of processing on the data retrieved from the RAM 1214 and writes back results into the RAM 1214. The various types of processing include various types of operations, information processing, conditional determination, conditional branching, unconditional branching, information retrieval/replacement, etc., which are described in the specification and specified by instruction sequences of the programs. Moreover, the CPU 1212 retrieves information in files and databases stored in the storage medium. For example, when the storage medium stores a plurality of entries each having one attribute value of a first attribute related to another attribute value of a second attribute, the CPU 1212 retrieves an entry satisfying a condition specified by the attribute value of the first attribute from the plurality of entries, retrieves the attribute value of the second attribute stored in the retrieved entry, and obtains the attribute value of the second attribute related to the first attribute that satisfies a pre-set condition.

The foregoing programs or software modules may be stored in the computer 1200 or in the computer-readable storage medium adjacent to the computer 1200. Moreover, the storage medium such as the hard drive or the RAM provided by a server system connected to a special-purpose communication network or the Internet may be the computer-readable storage medium. As such, the programs are supplied to the computer 1200 through the network.

It should be noted that an order of performing various processes such as actions, sequences, steps, and stages in the devices, systems, programs, and methods illustrated in the claims, the specification, and the drawings of the specification, may be implemented in any order unless specifically stated “before” or “in advance,” or as long as an output of a preceding process is not used in a succeeding process. The operation procedure illustrated in the claims, the specification, and the drawings of the specification has been described using “first” or “next” for convenience of illustration, but it does not mean that the order of the operation procedure must be implemented.

Various embodiments of the present disclosure are merely used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. Thus, the scope of present disclosure should be determined by the appended claims.

Numerals and labels in the drawings are summarized below.
10 UAV
20 UAV main body
30 UAV control circuit
31 Determination circuit
32 Memory
33 Flight control circuit
34 Communication interface
40 Propulsion system
41 GPS receiver
42 IMU
43 Magnetic compass
44 Barometric altimeter
50 Gimbal
60 Photographing device
100 Photographing device
102 Photographing assembly
110 Photographing control circuit
120 Image sensor
130 Memory
141 Electrical contact
142 Electrical contact
150 Lock pin
152 Lock release button
200 Lens assembly
201 Insertion hole
210 Lens
212 Lens driving mechanism
220 Lens control circuit
222 Memory
300 Remote operation device
1200 Computer
1210 Host controller
1212 CPU
1214 RAM
1220 Input/output controller
1222 Communication interface
1230 ROM

What is claimed is:

1. A control device comprising:
a memory storing a program; and
a processor configured to execute the program to restrict movement of a movable body in response to detecting that a mounting state of a detachable lens assembly at a photographing device of the movable body does not satisfy a pre-set condition.

2. The control device of claim 1, wherein the processor is further configured to execute the program to determine whether the mounting state of the detachable lens assembly satisfies the pre-set condition.

3. The control device of claim 2, wherein the processor is further configured to execute the program to, before the movable body starts moving:
determine whether the mounting state of the detachable lens assembly satisfies the pre-set condition; and
in response to determining that the mounting state of the detachable lens assembly does not satisfy the pre-set condition, restrict the movable body from starting to move.

4. The control device of claim 2, wherein:
the movable body includes an unmanned aerial vehicle (UAV); and
the processor is further configured to execute the program to, before the UAV takes off:
determine whether the mounting state of the detachable lens assembly satisfies the pre-set condition; and
in response to determining that the mounting state of the detachable lens assembly does not satisfy the pre-set condition, restrict the UAV from taking off.

5. The control device of claim 2, wherein the processor is further configured to execute the program to, while the movable body is moving:
determine whether the mounting state of the detachable lens assembly satisfies the pre-set condition; and
in response to determining that the mounting state of the detachable lens assembly does not satisfy the pre-set condition, restrict the movement of the movable body.

6. The control device of claim 2, wherein:
the movable body includes an unmanned aerial vehicle (UAV); and
the processor is further configured to execute the program to, during flight of the UAV:
determining whether the mounting state of the detachable lens assembly satisfies the pre-set condition; and
in response to determining that the mounting state of the detachable lens assembly does not satisfy the pre-set condition, restrict the flight of the UAV.

7. The control device of claim 6, wherein the processor is further configured to execute the program to:
in response to determining that the mounting state of the detachable lens assembly does not satisfy the pre-set condition, control the UAV to land.

8. The control device of claim 6, wherein the processor is further configured to execute the program to notify a user to land the UAV when the mounting state of the detachable lens assembly at the photographing device of the movable body does not satisfy the pre-set condition.

9. The control device of claim 6, wherein the processor is further configured to execute a program to notify a user by displaying a warning message requesting emergency landing on a display.

10. The control device of claim 2, wherein the processor is further configured to execute the program to, during the movement of the movable body:
determine whether the mounting state of the detachable lens assembly satisfies the pre-set condition; and
in response to determining that the mounting state of the detachable lens assembly does not satisfy the pre-set condition, send a notification to indicate that the mounting state of the detachable lens assembly does not satisfy the pre-set condition.

11. The control device of claim 2, wherein:
the movable body includes an unmanned aerial vehicle (UAV) including a supporting mechanism that rotatably supports the photographing device; and
the processor is further configured to execute the program to, during flight of the UAV:
determine whether the mounting state of the detachable lens assembly satisfies the pre-set condition; and
in response to determining that the mounting state of the detachable lens assembly does not satisfy the pre-set condition, restrict the flight of the UAV and restrict the supporting mechanism from driving the photographing device to rotate.

12. The control device of claim 2, wherein the processor is further configured to execute the program to determine that the mounting state of the detachable lens assembly does not satisfy the pre-set condition in response to detecting that the detachable lens assembly is not mechanically fixed to the photographing device by a lock pin.

13. The control device of claim 2, wherein the processor is further configured to execute the program to determine that the mounting state of the detachable lens assembly does not satisfy the pre-set condition in response to detecting that the detachable lens assembly is not electrically connected to the photographing device through electrical contacts.

14. The control device of claim 2, wherein the processor is further configured to execute the program to determine that the mounting state of the detachable lens assembly satisfies the pre-set condition in response to detecting that the detachable lens assembly is mechanically fixed to the photographing device by a lock pin and the detachable lens assembly is electrically connected to the photographing device through electrical contacts.

15. The control device of claim 1, wherein the processor is further configured to execute the program to notify a user that the mounting state of the detachable lens assembly at the photographing device of the movable body does not satisfy the pre-set condition.

16. The control device of claim 1, wherein the processor is further configured to execute the program to display a message indicating that the mounting state of the lens assembly at the photographing device dose not satisfy the pre-set condition on a display.

17. The control device of claim 16, wherein the display is mounted on a remote operation device.

18. A movable body comprising:
a photographing device; and
a control device configured to restrict movement of the movable body in response to detecting that a mounting state of a detachable lens assembly at the photographing device does not satisfy a pre-set condition.

19. The movable body of claim 18, wherein:
the control device includes a determination circuit configured to determine whether the mounting state of the detachable lens assembly satisfies the pre-set condition.

20. A control method comprising:
determining whether a mounting state of a detachable lens assembly at a photographing device of a movable body satisfies a pre-set condition; and
restricting movement of the movable body in response to determining that the mounting state of the detachable lens assembly does not satisfy the pre-set condition.
